(19) United States
(12) Patent Application Publication
(10) Pub. No.: US 2008/0147240 A1
(43) Pub. Date: Jun. 19, 2008

(54) APPARATUS FOR SEPARATING A COMPOSITE LIQUID WITH PROCESS CONTROL ON A CENTRIFUGE ROTOR

(75) Inventors: Darryl Hudock, Highlands Ranch, CO (US); Peter FLETCHER-HAYNES, Denver, CO (US); Wilfred Ivan TUCKER, Centennial, CO (US); Daniel A. JOSEPH, Golden, CO (US); Steven INGEBRIGTSEN, Lakewood, CO (US); John Sample, Glendale, CO (US)

Correspondence Address: GAMBRO BCT, INC;IP DEPARTMENT, 10810 WEST COLLINS AVE, LAKEWOOD, CO, 80215, US

(73) Assignee: GAMBRO BCT INC., Lakewood, CO (US)

(21) Appl. No.: 11/679,079

(22) Filed: Feb. 26, 2007

Related U.S. Application Data
(60) Provisional application No. 60/870,635, filed on Dec. 19, 2006.

(51) Int. Cl. G01N 9/30; G05B 21/00

(52) U.S. Cl. 700/266; 422/72

(57) ABSTRACT

An apparatus and a method for separating at least two discrete volumes of a composite liquid into at least two components. Independent microprocessors are provided on a rotor of a centrifugal separation apparatus, which respond to commands from a control computer, gather sensor data and independently control devices on the rotor to process one or more volumes of a composite liquid such as blood. Multiple microprocessors communicate with the control computer across a single communication channel, such as a pair of slip rings or an infrared communications link.

The present invention relates to an apparatus and a method for separating at least two discrete volumes of a composite liquid into at least two components, and in particular to a centrifugal separation apparatus with control components located on a rotor of the centrifugal separation apparatus. Independent microprocessors are provided on a rotor of a centrifugal separation apparatus, which respond to commands from a control computer, gather sensor data and independently control devices on the rotor to process one or more volumes of a composite liquid such as blood. Multiple microprocessors communicate with the control computer across a single communication channel, such as a pair of slip rings or an infrared communications link.

The apparatus and a method of the invention are particularly appropriate for the separation of biological fluids comprising an aqueous component and one or more cellular components. For example, potential uses of the invention include: extracting a plasma component and a cellular component (including platelets, white blood cells, and red blood cells) from a volume of whole blood; extracting a plasma component, in which a substantial amount of platelets is suspended, and a red blood cell component from a volume of whole blood, the white blood cells being subsequently removed by filtration from the platelet component and the red blood cell component; or extracting a plasma component, a platelet component, and a red blood cell component from a volume of whole blood, the white blood cells being subsequently removed by filtration from the platelet component and the red blood cell component.

An apparatus for processing blood components is known, for example, from WO 03/089027. This apparatus comprises a centrifuge adapted to cooperate with an annular separation bag connected to at least one product bag, e.g. a platelet component bag. The centrifuge includes a rotor having a turntable for supporting the separation bag, and a central compartment for containing the product bag connected to the separation bag, and a squeezing system for squeezing the separation bag and causing the transfer of a separated component (e.g. platelets suspended in plasma) from the separation bag into the product bag. With this apparatus, a single discrete volume of blood is processed at once.

An apparatus for simultaneously processing multiple volumes of blood into components is disclosed in [B-0326]. In that device, control circuits, for example a microcomputer, are not located on a centrifuge rotor. Multiple slip rings must be used to communicate control signals to valves on the centrifuge rotor or to transmit information signals from sensors on the rotor.

An object of the present invention is to provide for simultaneous processing of multiple volumes of blood on a centrifuge rotor. Mounting dedicated control circuits on the rotor minimizes communications channels from a main control circuit or computer to the movable rotor. Preferably, electrical connections to the rotor are reduced, preferably to two communications connections. The communications connections may be slip rings, infrared communications transponders, or other data communication links. Operating power for dedicated control circuits, valves and sensors on the rotor may be transmitted to the rotor by slip rings, or by a dynamo comprised of magnets and electromagnetic coils. A system ground may also be provided for discharge of static electric charges that might otherwise build up on the rotor.

Other features and advantages of the invention will appear from the following description and accompanying drawings, which are to be considered exemplary only.

### BRIEF DESCRIPTION OF THE DRAWINGS

FIG. 1 is a schematic view of a first set of bags designed for cooperating with a separation apparatus.

FIG. 2 is a schematic view of a second set of bags designed for cooperating with a separation apparatus.

FIGS. 3a, 3b are schematic views of two variants of a detail of the set of bags of FIG. 2.

FIG. 4 is a schematic view, partly in cross-section along a diametric plane, of a separation apparatus.

FIG. 5 is a top view of the rotor of the separation apparatus of FIG. 4.

FIG. 6 is a perspective view of a passive balancing unit for a separation apparatus.

FIG. 7 is a perspective view of a rotor of a second embodiment of a separation apparatus.

FIG. 8 is a cross-section view of the rotor of FIG. 7, along a diametric plane.

FIG. 9 is a top view of the rotor of FIG. 7.

FIG. 10 is a perspective view of a central or “spider” assembly for the rotor assembly of FIG. 7.

FIG. 11 is a top view of the central assembly of FIG. 10.

FIG. 12 is a cross section view of the central assembly taken on the line 12-12 of FIG. 11.

FIG. 13 is a cross section view of the central assembly taken on the line 13-13 of FIG. 11.

FIG. 14 is a detail view of a sensor on the central assembly shown in FIG. 12.

FIG. 15 is a perspective view of sensors shown in FIGS. 10 through 14.

FIG. 16 is a perspective view of circuit boards comprising on-rotor microprocessors for the central assembly of FIGS. 10-13.

FIGS. 17A and 17B are a schematic diagram of an on-rotor control circuit comprising a microprocessor.

FIG. 18 is a schematic diagram of a photodiode sensor circuit.

FIG. 19 is a schematic diagram of a valve sensor circuit.

FIG. 20 is a schematic diagram of a valve driver circuit.

FIG. 21 is a schematic diagram of distributed software control functions.

### DETAILED DESCRIPTION

For the sake of clarity, the invention will be described with respect to a specific use, namely the separation of whole blood into at least two components, in particular into a plasma component and a red blood cell component, or into a plasma component, a platelet component and a red blood cell component. The discrete volume mentioned hereunder will typically be the volume of a blood donation. The volume of a blood donation may vary from one donor to another one (450 ml plus or minus 10%). It is also recalled that the proportion of the components of blood usually varies from one donor to another one, in particular the hematocrit, which is the ratio of the volume of the red blood cells to the volume of the sample of whole blood considered. In other words, the density of blood may slightly vary for one donor to another one. It should be understood however that this specific use is exemplary only.

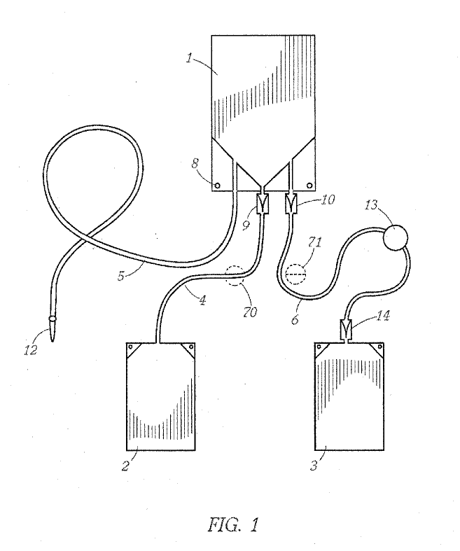

FIG. 1 shows an example of a set of bags adapted to the separation of a composite liquid (e.g. whole blood) into a first component (e.g. a plasma component containing or not a substantial amount of suspended platelets) and a second component (e.g. a blood cell component). This bag set comprises a flexible separation bag 1 and two flexible satellite bags 2, 3 connected thereto.

When the composite liquid is whole blood, the separation bag 1 has two purposes, and is successively used as a collection bag and as a separation bag. It is intended for initially receiving a discrete volume of whole blood from a donor (usually about 450 ml) and to be used later as a separation chamber in a separation apparatus. The separation bag 1 is flat and generally rectangular. It is made of two rectangular sheets of plastic material that are welded together so as to define an interior space having a main rectangular portion connected to a triangular top downstream portion. A first tube 4 is connected to the tip of the triangular portion, and a second tube 5 and a third tube 6 are connected to either lateral edges of the triangular portion, respectively. The proximal ends of the three tubes 4, 5, 6 are embedded between the two sheets of plastic material so as to be parallel. The separation bag 1 further comprises a hole 8 in each of its corners that are adjacent to the three tubes 4, 5, 6. The holes 8 are used to secure the separation bag to a separation cell, as will be described later.

The separation bag initially contains a volume of anti-coagulant solution (typically about 63 ml of a solution of citrate phosphate dextrose for a blood donation of about 450 ml), and the first and third tubes 4, 6 are fitted at their proximal end with a breakable stopper 9, 10 respectively, blocking a liquid flow.

The second tube 5 is a collection tube having a needle 12 connected to its distal end. At the beginning of a blood donation, the needle 12 is inserted in the vein of a donor and blood flows into the collection (separation) bag 1. After a desired volume of blood has been collected in the collection (separation) bag 1, the collection tube 5 is sealed and cut.

The first satellite bag 2 is intended for receiving a plasma component. It is flat and substantially rectangular. It is connected to the distal end of the first tube 4. The second satellite bag 3 is intended for receiving a red blood cell component. It is flat and substantially rectangular. It is connected to the distal end of the third tube 6. The third tube 6 comprises two segments respectively connected to the inlet and the outlet of a leuko-reduction filter 13. The second satellite bag 3 contains a volume of storage solution for red blood cells, and the third tube 6 is fitted at its distal end with a breakable stopper 14 blocking a liquid flow.

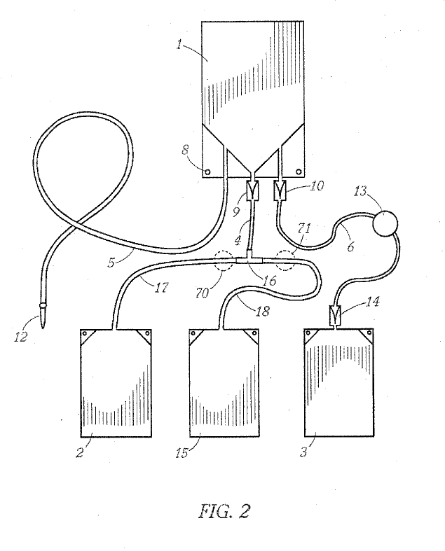

FIG. 2 shows an example of a set of bags adapted to the separation of a composite liquid (e.g., whole blood) into a first component (e.g., a plasma component), an intermediate component (e.g., a platelet component), and a second component (e.g., a red blood cell component). This bag set comprises a flexible separation bag 1 and three flexible satellite bags 2, 3, 15 connected thereto.

This second set of bags differs from the set of bags of FIG. 1 in that it comprises a third satellite bag 15, which is intended to receive a platelet component, and a T-shaped three-way connector 16 having its leg connected by the first tube 4 to the separation bag 1, a first arm connected by a fourth tube 17 to the first satellite bag 2 (plasma component bag), and a second arm connected by a fifth tube 18 to the third satellite bag 15 (platelet component bag). Like the first and second satellite bags 2, 3, the third satellite bag 15 is flat and substantially rectangular.

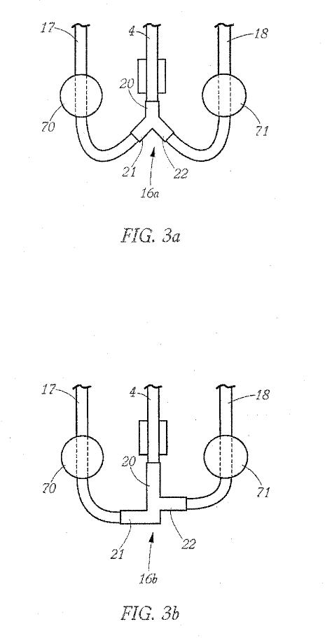

FIGS. 3a, 3b show two variants of the T-shaped three-way connector 16 of the bag set of FIG. 2. The three-way connector 16a shown in FIG. 3a has the shape of a regular three-point star having a first outlet channel 21 and a second outlet channel 22 that are connected to an inlet channel 20 at an angle of about 120 degrees. The three-way connector 16b shown in FIG. 3b, defines a first outlet channel 21 and a second outlet channel 22 that are perpendicularly connected to an inlet channel 20 and are offset along the inlet channel 20 so that the first outlet channel 21 is further than the second outlet channel 22 from the end of the inlet channel 20 that is connected to the first tube 4.

The three-way connectors 16, 16a, 16b are arranged such that when the separation bag of FIG. 2 (or any of its variants represented in FIGS. 3a, 3b) is mounted in a separation apparatus (to be described in detail below), in which a separation cell for a separation bag 1, a storage container for the satellite bags 2, 3, 15, and a first and second pinch valve members for allowing or stopping a flow of liquid in the fourth and fifth tubes 17, 18 are arranged in this order along a radial direction from a rotation axis of the separation apparatus, with the pinch valve members being the closest to the rotation axis. In this particular configuration, when the fourth and fifth tubes 16, 17 are engaged in the first and second pinch valve members as shown in FIGS. 2, 3a, 3b, then the three-way connector 16, 16b, or a bend in the fourth and fifth tubes 17, 18 in the case of the connector of FIG. 3a, are the closest portion(s) of the whole bag set to the rotation axis. The results of this disposition are that, when the separation apparatus rotates, any air in the bag set will gather in the connector in an area that is the closest to the rotation axis (junction point of the three channels 20, 21, 22 in the connectors shown in FIGS. 2, 3b) or in the bends in the fourth and fifth tube 17, 18 between the connector and the pinch valve members 17, 18 when the connector used is the connector of FIG. 3a. This air buffer between the separation bag and the satellite bag will prevent any undesirable siphoning of contents of a satellite bag into the separation bag under centrifugation forces.

The three-way connector 16b presents a particular interest when the bag set of FIG. 2 is used to separate a plasma component and a platelet component. When the plasma component has been transferred into the first satellite bag 2 and the platelet component has been transferred into the third satellite bag 15, the connector 16b shown in FIG. 3b allow for flushing the second channel 22, which may contain remaining platelets, with a small volume of plasma trapped in the fourth tube 17 between the connector 16b and the first pinch valve member.

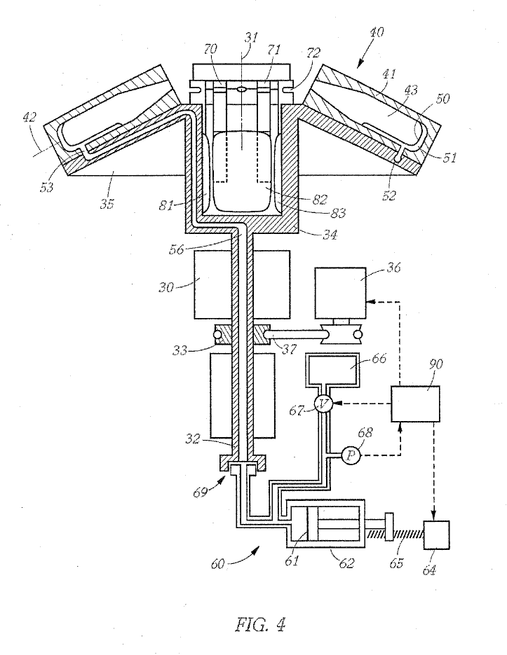

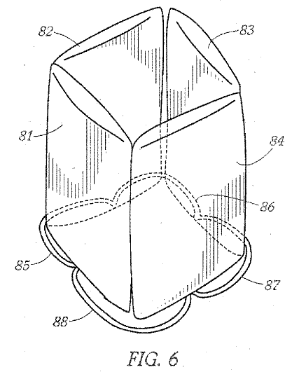

FIGS. 4, 5, and 6 show a first embodiment of an apparatus for simultaneously separating by centrifugation four discrete volumes of a composite liquid. The apparatus comprises a centrifuge adapted to receive four of either set of bags shown in FIGS. 1 and 2, with the four discrete volumes of a composite liquid contained in the four separation bags; a component transferring means for transferring at least one separated component from each separation bag into a satellite bag connected thereto; a first balancing means for initially balancing the rotor when the weights of the four separation bags are different; and a second balancing means for balancing the rotor when the weights of the separated components transferred into the satellite bags cause an unbalance of the rotor.

The centrifuge comprises a rotor that is supported by a bearing assembly 30 allowing the rotor to rotate around a rotation axis 31. The rotor comprises a cylindrical rotor shaft 32 to which a pulley 33 is connected; a storage means comprising a central cylindrical container 34 for containing satellite bags, which is connected to the rotor shaft 32 at the upper end thereof so that the longitudinal axis of the rotor shaft 32 and the longitudinal axis of the container 34 coincide with the rotation axis 31, and a frusto-conical turntable 35 connected to the upper part of the central container 34 so that its central axis coincides with the rotation axis 31. The frusto-conical turntable 35 flares underneath the opening of the container 34. Four identical separation cells 40 are mounted on the turntable 35 so as to form a symmetrical arrangement with respect to the rotation axis 31. The centrifuge further comprises a motor 36 coupled to the rotor by a belt 37 engaged in a groove of the pulley 33 so as to rotate the rotor about the rotation axis 31.

Each separation cell 40 comprises a container 41 having the general shape of a rectangular parallelepiped. The separation cells 40 are mounted on the turntable 35 so that their respective median longitudinal axes 42 intersect the rotation axis 31, so that they are located substantially at the same distance from the rotation axis 31, and so that the angles between their median longitudinal axes 42 are substantially the same (i.e., 90 degrees). The exact position of the separation cells 40 on the turntable 35 is adjusted so that the weight on the turntable is equally distributed when the separation cells 40 are empty, i.e., so that the rotor is balanced. It results from the arrangement of the separating cells 40 on the turntable 35 that the separating cells 40 are inclined with respect to the rotation axis 31 of an acute angle equal to the angle of the frustum of a cone that geometrically defines the turntable 35.

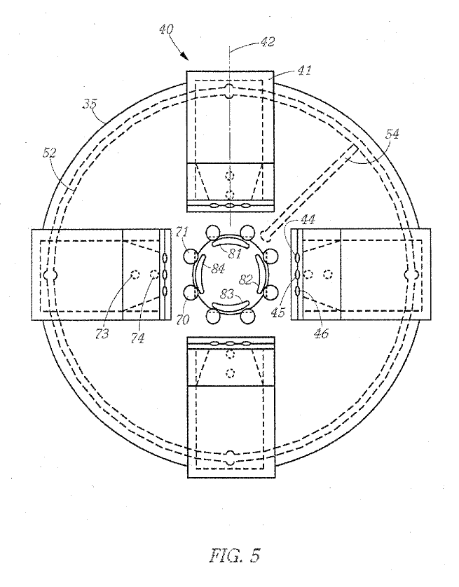

Each container 41 comprises a cavity 43 that is so shaped and dimensioned as to loosely accommodate a separation bag 1 full of liquid, of the type shown in FIGS. 1 and 2. The cavity 43 (which will be referred to later also as the “separation compartment”) is defined by a bottom wall, which is the farthest to the rotation axis 31, a lower wall, which is the closest to the turntable 35, an upper wall, which is opposite to the lower wall, and two lateral walls. The cavity 43 comprises a main part, extending from the bottom wall, which has substantially the shape of a rectangular parallelepiped with rounded angles, and an upper part, which has substantially the shape of a prism having convergent triangular bases. In other words, the upper part of the cavity 43 is defined by two couples of opposite walls converging towards the central median axis 42 of the cavity 43. One interest of this design is to cause a radial dilatation of the thin layer of a minor component of a composite fluid (e.g. the platelets in whole blood) after separation by centrifugation, and makes it more easily detectable in the upper part of a separation bag. The two couples of opposite walls of the upper part of the separation cell 40 converge towards three cylindrical parallel channels 44, 45, 46 (see FIG. 5), opening at the top of the container 41, and in which, when a separation bag 1 is set in the container 41, the three tubes 4, 5, 6 extend.

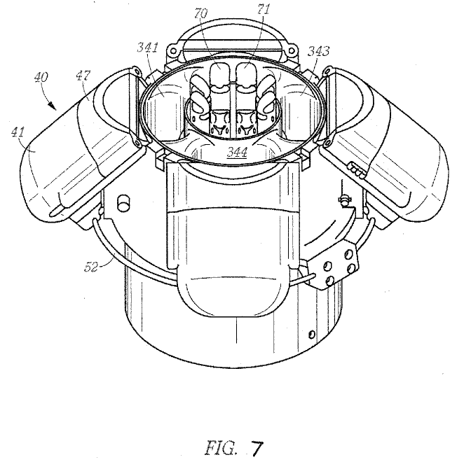

The container 41 also comprises a hinged lateral lid 47 (see FIG. 7), which is comprised of an upper portion of the external wall of the container 41, i.e. the wall that is opposite to the turntable 35. The lid 47 is so dimensioned as to allow, when open, an easy loading of a separation bag 1 full of liquid into the separation cell 40. The container 41 comprises a fast locking means (not shown) by which the lid 47 can be locked to the remaining part of the container 41. The container 41 also comprises a securing means for securing a separation bag 1 within the separation cell 40. The bag securing means comprises two pins protruding on the internal surface of the lid 47, close to the top of separation cell 40, and two corresponding recesses in the upper part of the container 41. The two pins are so spaced apart and dimensioned as to fit into the two holes 8 in the upper corner of a separation bag 1.

The separation apparatus further comprises a component transferring means for transferring at least one separated component from each separation bag into a satellite bag connected thereto. The component transferring means comprises a squeezing system for squeezing the separation bags 1 within the separation compartments 43 and causing the transfer of separated components into satellite bags 2, 3, 15. The squeezing system comprises a flexible diaphragm 50 that is secured to each container 41 so as to define an expandable chamber 51 in the cavity thereof. More specifically, the diaphragm 50 is dimensioned so as to line the bottom wall of the cavity 43 and a large portion of the lower wall of the cavity 43, which is the closest to the turntable 35. The squeezing system further comprises a peripheral circular manifold 52 that forms a ring within the turntable 35 extending close to the periphery of the turntable 35. Each expansion chamber 51 is connected to the manifold 52 by a supply channel 53 that extends through the wall of the respective container 41, close to the bottom thereof. The squeezing system further comprises a hydraulic pumping station 60 for pumping a hydraulic liquid in and out the expandable chambers 51 within the separation cells 40. The hydraulic liquid is selected so as to have a density slightly higher than the density of the more dense of the components in the composite liquid to be separated (e.g. the red blood cells, when the composite liquid is blood). As a result, during centrifugation, the hydraulic liquid within the expandable chambers 51, whatever the volume thereof, will generally remain in the most external part of the separation cells 40. The pumping station 60 is connected to the expandable chambers 51, through a rotary fluid coupling 69, by a duct 56 that extends through the rotor shaft 32, the bottom and lateral wall of the central container 34, and, from the rim of the central container 34, radially through the turntable 35 where it connects to the manifold 52.

The pumping station 60 comprises a piston pump having a piston 61 movable in a hydraulic cylinder 62 fluidly connected via a rotary fluid coupling 69 through the duct 56 to the rotor duct 54 (FIG. 5). A stepper motor 64 that moves a lead screw 65 linked to the piston rod actuates the piston 61. The hydraulic cylinder 62 is also connected to a hydraulic liquid reservoir 66 having an access controlled by a valve 67 for selectively allowing the introduction or the withdrawal of hydraulic liquid into and from a hydraulic circuit including the hydraulic cylinder 62, the duct 56, the rotor duct 54, and the expandable hydraulic chambers 51. A pressure gauge 68 is connected to the hydraulic circuit for measuring the hydraulic pressure therein.

The separation apparatus further comprises four pairs of first and second pinch valve members 70, 71 that are mounted on the rotor around the opening of the central container 34. Each pair of pinch valve members 70, 71 faces one separation cell 40, with which it is associated. The pinch valve members 70, 71 are designed for selectively blocking or allowing a flow of liquid through a flexible plastic tube, and selectively sealing and cutting a plastic tube. Each pinch valve member 70, 71 comprises an elongated cylindrical body 100 and a head 102 having a groove 72 that is defined by a stationary upper jaw 104 and a lower jaw 106 movable between an open and a closed position. The groove 72 is so dimensioned that one of the tubes 4, 17, 18 of the bag sets shown in FIGS. 1 and 2 can be snuggly engaged therein when the lower jaw is in the open position. The elongated body 100 contains a mechanism 108 for moving the lower jaw and it is connected to a radio frequency generator that supplies the energy necessary for sealing and cutting a plastic tube. The pinch valve members 70, 71 are mounted inside the central container 34, adjacent the interior surface thereof, so that their longitudinal axes are parallel to the rotation axis 31 and their heads protrude above the rim of the container 34. The position of a pair of pinch valve members 70, 71 with respect to a separation bag 1 and the tubes 4, 17, 18 connected thereto when the separation bag 1 rests in the separation cell 40 associated with this pair of pinch valve members 70, 71 is shown in doted lines in FIGS. 1 and 2. Electric power is supplied to the pinch valve members 70, 71 through a slip ring array 38 that is mounted around a lower portion of the rotor shaft 32.

The separation apparatus further comprises four pairs of sensors 73, 74 for monitoring the separation of the various components occurring within each separation bag when the apparatus operates. Each pair of sensors 73, 74 is embedded in the lid 47 of the container 41 of each separation cell 40 along the median longitudinal axis 42 of the container 41, a first sensor 73 being located the farthest and a second sensor 74 being located the closest to the rotation axis 31. When a separation bag 1 rests in the container 41 and the lid 47 is closed, the first sensor 73 (later the bag sensor) faces the upper triangular part of the separation bag 1 and the second sensor 74 (later the tube sensor) faces the proximal end of the first tube 4. The bag sensor 73 is able to detect blood cells in a liquid. The tube sensor 74 is able to detect the presence or absence of liquid in the tube 4 as well as to detect blood cells in a liquid. Each sensor 73, 74 may comprise a photocell including an infrared LED and a photo-detector. Electric power is supplied to the sensors 73, 74 through the slip ring array 38 that is mounted around the lower portion of the rotor shaft 32.

The separation apparatus further comprises a first balancing means for initially balancing the rotor when the weights of the four separation bags 1 contained in the separation cells 40 are different. The first balancing means substantially comprises the same structural elements as the elements of the component transferring means described above, namely: four expandable hydraulic chambers 51 interconnected by a peripheral circular manifold 52, and a hydraulic liquid pumping station 60 for pumping hydraulic liquid into the hydraulic chambers 51 through a rotor duct 56, which is connected to the circular manifold 52. In order to initially balance the rotor, whose four separation cells 40 contain four discrete volumes of a composite liquid that may not have the same weight (because the four volumes may be not equal, and/or the density of the liquid may slightly differ from one volume to the other one), the pumping station 60 is controlled so as to pump into the interconnected hydraulic chambers 51, at the onset of a separation process, a predetermined volume of hydraulic liquid that is so selected as to balance the rotor in the most unbalanced situation. For whole blood, the determination of this balancing volume takes into account the maximum difference in volume between two blood donations, and the maximum difference in hematocrit (i.e. in density) between two blood donations. Under centrifugation forces, the hydraulic liquid will distribute unevenly in the four separation cells 40 depending on the difference in weight of the separation bags 1, and balance the rotor. In order to get an optimal initial balancing, the volume of the cavity 43 of the separation cells 40 should be selected so that the cavities 43, whatever the volume of the separation bags 1 contained therein, are not full after the determined amount of hydraulic liquid has been pumped into the interconnected expansion chambers 51.

The separation apparatus may also have a second balancing means, for balancing the rotor when the weights of the components transferred into the satellite bags 2, 3, 15 in the central container 34 are different. For example, when two blood donations have the same hematocrit and different volumes, the volumes of plasma extracted from each donation are different, and the same is true when two blood donations have the same volume and different hematocrit. As shown in FIGS. 4, 5, 6 the second balancing means comprises four flexible rectangular pouches 81, 82, 83, 84 that are interconnected by four tube sections 85, 86, 87, 88, each tube section connecting two adjacent pouches by the bottom thereof. The pouches 81, 82, 83, 84 contain a volume of balancing liquid having a density close to the density of the composite liquid. The volume of balancing liquid is so selected as to balance the rotor in the most unbalanced situation. The four pouches 81, 82, 83, 84 are so dimensioned as to line the inner surface of the central container 34 and to have an internal volume that is larger than the volume of balancing liquid so that the balancing liquid can freely expand in any of the pouches 81, 82, 83, 84. In operation, if, for example, four satellite bags 2 respectively adjacent to the four pouches 81, 82, 83, 84 receive different volumes of a plasma component, the four satellite bags 2 will press unevenly, under centrifugation forces, against the four pouches 81, 82, 83, 84, which will result in the balancing liquid becoming unevenly distributed in the four pouches 81, 82, 83, 84 and compensating for the difference in weight in the satellite bags 2.

The separation apparatus further comprises a control computer 90 including a control unit (e.g., a microprocessor) and a memory unit for providing the control computer with information and programmed instructions relative to various separation protocols (e.g. a protocol for the separation of a plasma component and a blood cell component, or a protocol for the separation of a plasma component, a platelet component, and a red blood cell component) and to the operation of the apparatus in accordance with such separation protocols. In particular, the control computer is programmed for receiving information relative to the centrifugation speed(s) at which the rotor is to be rotated during the various stages of a separation process (e.g. stage of component separation, stage of a plasma component expression, stage of suspension of platelets in a plasma fraction, stage of a platelet component expression, etc), and information relative to the various transfer flow rates at which separated components are to be transferred from the separation bag 1 into the satellite bags 2, 3, 15. The information relative to the various transfer flow rates can be expressed, for example, as hydraulic liquid flow rates in the hydraulic circuit, or as rotation speeds of the stepper motor 64 of the hydraulic pumping station 60. The control computer 90 is further programmed for receiving, directly or through the memory, information from the pressure gauge 68 and from the four pairs of photocells 73, 74 and for controlling the centrifuge motor 36, the stepper motor 64 of the pumping station 60, and the four pairs of pinch valve members 70, 71 so as to cause the separation apparatus to operate along a selected separation protocol.

FIGS. 7, 8, and 9 show the rotor of an embodiment of a separation apparatus for four discrete volumes of a composite liquid. The rotor of this embodiment essentially differs from the rotor of the embodiment of FIGS. 4 and 5 in the spatial arrangement of the pinch valve members 70, 71 and of the storage means for the satellite bags with respect to the separation cells 40. In this embodiment, the storage means, instead of comprising a central container, comprises four satellite containers 341, 342, 343, 344 that are arranged around a central cylindrical cavity 340, in which the four pairs of pinch valve member 70, 71 are mounted with their longitudinal axes parallel to the rotation axis 31. The cavity 43 of a satellite container 341, 342, 343, 344 has a regular bean-like cross-section, and a central longitudinal axis that is parallel to the rotation axis 31 and intersects the longitudinal axis 42 of the associated separation cell 40.

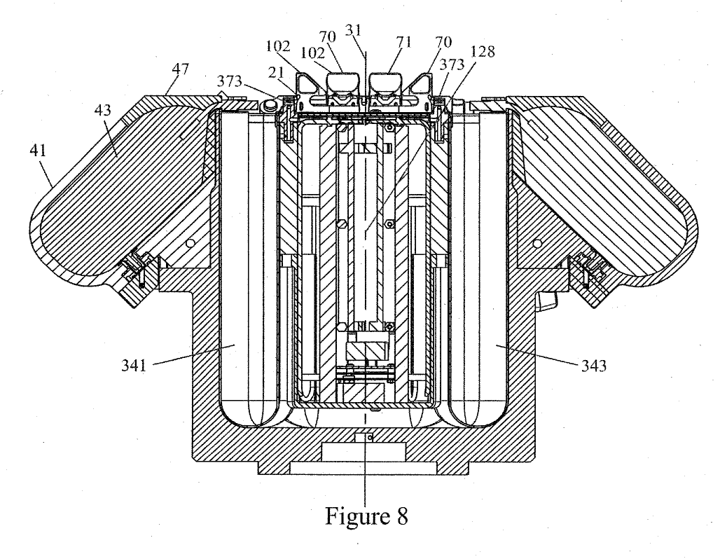

When a set of bags as shown in FIGS. 2, 3a, 3b is mounted on the rotor of FIGS. 8 to 9, the separation bag 1 and the satellite bags 2, 3, 15 are located beyond the associated pinch valves members 70, 71 with respect to the rotation axis 31. The tubes 4, 17, 18 and the three-way connector 16, 16a, 16b connecting the bags are then in the position shown in FIGS. 2, 3a, 3b.

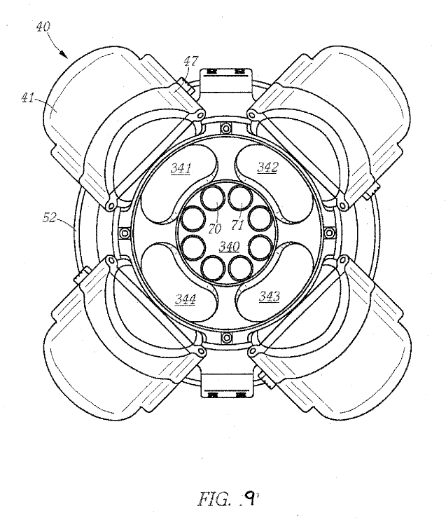

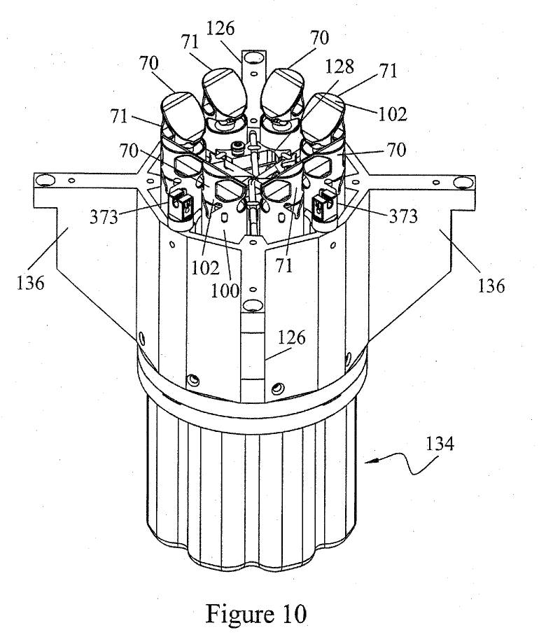

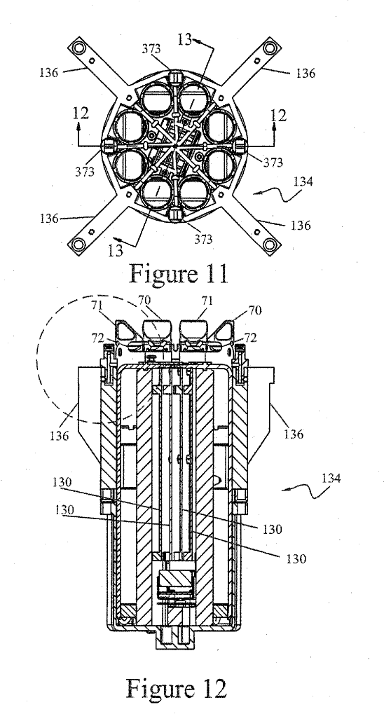

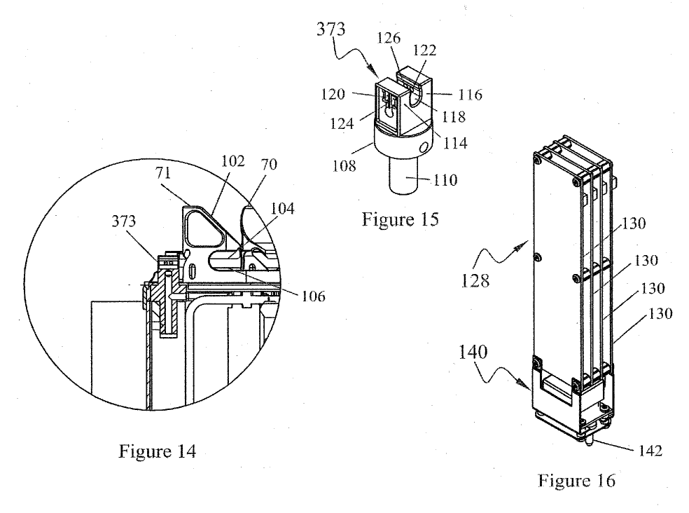

In the embodiment of FIGS. 8 through 14, the tube 4 adjacent the T connector 16 is placed in a fluid composition sensor 373, shown in perspective view in FIG. 15. The sensor 373 comprises a base 108 supported on a mounting pin 110. The base 108 carries a sensor mounting bracket 112 that has two symmetrical arms 114, 116 defining a slot 118 for receiving the tube 4. Each arm carries a photodiode 120, 122 and an LED 124, 126. The LED on one arm, for example LED 124 on arm 114, is mounted opposite the photodiode on the other arm, for example photodiode 122 on arm 116. The LEDs have different illumination characteristics, for example, a red light emitting LED and a green-light emitting LED. The red light may have a wavelength of about 624 nm and the green light may have a wavelength of about 571 nm. By pulsing first one LED and then the other LED, while simultaneously measuring light intensity at both photodiodes, four measurements can be obtained, that is, reflected red light, transmitted red light, reflected green light, and transmitted green light. Values of the sensed intensities can be compared in a controller or microcomputer against stored values to distinguish between components of liquid flowing in the tube 4, for example, to distinguish between plasma, buffy coat, and red blood cell components.

The pinch valve members 70, 71 and sensors 373 may be assembled in a spider assembly 134 and mounted as a unit in the rotor by means of arms 136 that fit between the satellite containers 341, 342, 343, 344. The spider assembly 134 also carries a control card assembly 128 comprised of a plurality of control cards 130. Each control card 130 comprises control circuitry for receiving signals from a sensor 373 and controlling a set of pinch valves 70, 71. Each control card 130 is independent from the other control cards and each can be separately replaced if there is a failure in the control circuitry on a particular control card. It will be recognized that the control cards 130 may receive a wide variety of sensor inputs, such as light or radiation, temperature, pressure, ultra sound, or any other useful sensed parameter related to the processing of blood or other fluid. Such sensors are known in the art. Disclosure herein of LED sensors is, therefore, strictly exemplary. In addition, the control card 130 may control a wide variety of devices, such as radio frequency sealers, directional valves, pumps, temperature controls and other known devices, as well as the pinch valves shown herein. Disclosure of the pinch valves is, therefore, strictly exemplary. Each control card has a unique software address and can therefore transmit information and receive instructions over a common communications channel. The communications channel may comprise a single set of slip rings, or an IR (infrared) communications link, or a similar communications system. Other multiple-unit separation systems, such as the system of [B-326], have required a communications channel for each of the valves and sensors. Because there was no independent control circuit on the rotor, sensors and valves had to be continuously controlled by the master control circuit or control computer 90. Slip ring communication channels are inherently noisy, and electrical noise increases as more channels are provided. The present apparatus reduces such communication problems and provides for increased process control by locating independent control circuits on the rotor of the separation apparatus. Further details of an exemplary control circuit will be set forth below.

The control cards 130 are mounted on a base 140 that has a plurality of pins 142 providing electrical connection between the cards and the other electrical components both on and off the rotor, as will be explained below. In general, electrical connections to electrical components off the rotor are shared by all the control cards 130, thus reducing the number of electrical connections between the rotor and other parts of the blood processing apparatus.

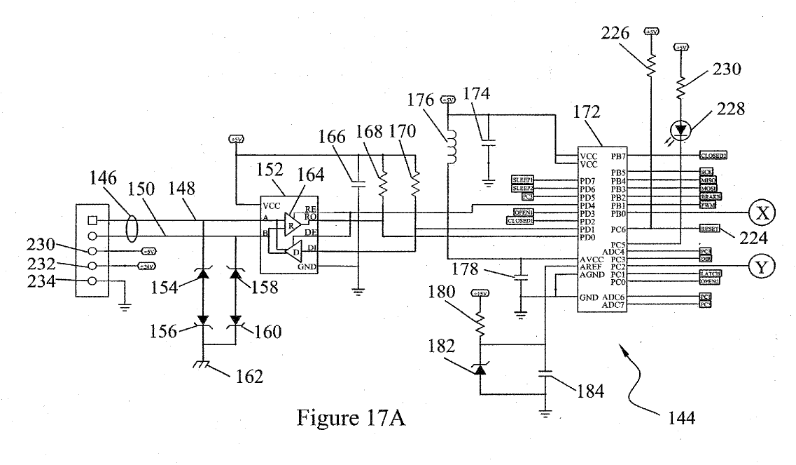

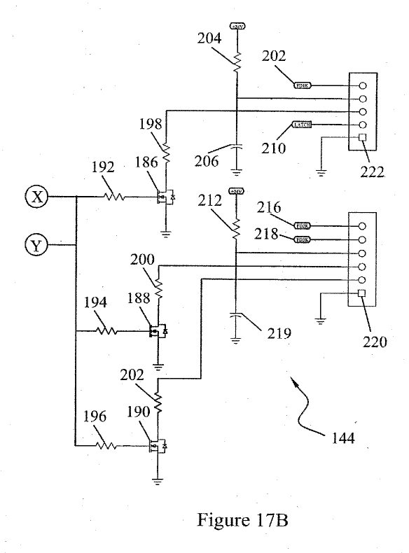

Each control card 130 carries a microprocessor-based control circuit 144, illustrated in FIGS. 17A and 17B. Electrical signals are sent to and received from the main controller or control computer 90 on a communications channel 146. The communications channel 146 is shared with all of the control circuits 144. Electrical signals referencing a particular control card are identified by an electronic address. As explained above, this allows the apparatus to function with a reduced number of communications connections, preferably one communications connection, bridging from the rotor to the frame of the blood processing apparatus. The communications channel 146 has a receiving line 148 and a transmitting line 150 connected to a transceiver buffer 152. The lines 148, 150, are connected through pairs of back-to-back Zener diodes 154, 156, 158, 160 to ground 162 (in this case, chassis ground). The Zener diodes provide surge protection, which is particularly important when a slip ring connection couples the rotor to the stationary components of the blood processing apparatus.

The transceiver 152 comprises a receive buffer 164 and a transmit buffer 166 powered from a 5V supply. In this exemplary embodiment, power sources at 5V, 15V and 24V are used for different functions in the circuits. Power supplies are well known in the art and need no further description here. The 5V supply to the transceiver 152 is buffered by a bypass capacitor 166. Pull-up resistors 168, 170 provide selected voltage levels on the input line PD0 and the output line PD1, respectively.

The transceiver 152 communicates with a microprocessor 172. In the illustrated embodiment a Mega 8 Flash microprocessor (model “ATMega8”) available from Atmel Corporation of San Jose, Calif. was used. This flash-memory based, programmable microprocessor has an integrated A-to-D converter, which is useful in connection with sensors that may be used in the apparatus. Other microprocessors may also be used without departing from the teachings specified herein. The microprocessor 172 is programmed to receive commands from the control computer 90, to receive information from sensors, to control devices on the rotor and to report status and results to the control computer without constant connection with or supervision from the control computer 90. The microprocessor 172 shares links to the control computer 90 with other microprocessors also located on the rotor and also operating independently. The microprocessor 172 is powered from the 5V power supply, which is connected to VCC and to a noise suppression capacitor 174, connected to ground. The 5V power supply is also connected through a filter inductor 176 to analog VCC, and powers the internal A-to-D converter. A filter capacitor 178 connects AVCC to both the internal analog ground and the internal digital ground and to an external ground. The internal A-to-D converter also employs an analog reference voltage derived from a 15V power source. The reference voltage input AREF is connected between a pull up resistor 180 and a Zener diode 182, which are connected in series between the 15 V power source and ground. A filter capacitor 184 may also be provided in parallel with the Zener diode 182.

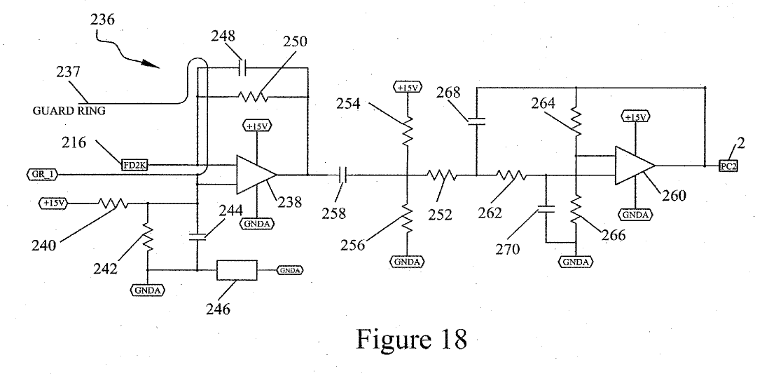

The microprocessor 172 also controls sensors on the fluid composition sensor 373 (or tube sensor 74) and the bag sensor 73. Control signals PB0 and PC2 activate MOSFET drivers 186, 188, 190 through biasing resistors 192, 194, 196 respectively. When activated, current flows through MOSFET driver 186 through resistor 198 from an LED in the bag sensor 73. The LED in the bag sensor 73 receives power from the 24V power supply through a coupling between a resistor 204 and filter capacitor 206, which are in series between the 24V power supply and ground. A signal FD1K 208 is received back from a photodiode (not shown) in the bag sensor 73 and communicated to the microprocessor at PC1 through a buffer circuit as shown in FIG. 18. The lid 47 may also be latched 210 by the microprocessor 172. The latch and photodiode are also connected to ground 222.

Similarly, the MOSFET drivers 188, 190 activate the fluid composition sensor 373. When activated, current flows through MOSFET drivers 188, 190 through resistors 200, 202 from the green LED 124 or the red LED 126, respectively, in the fluid composition sensor 373. The LEDs in the fluid composition sensor 373 receive power from the 24V power supply through a coupling between a resistor 212 and filter capacitor 214, which are in series between the 24V power supply and ground. A signal FD2K 216 is received back from the photodiode 120 and communicated to the microprocessor at PC2 through a buffer circuit as shown in FIG. 18. Similarly, a signal FD3K 218 is received back from the photodiode 122 and communicated to the microprocessor at PC3 through a buffer circuit as shown in FIG. 18. As explained above, the photodiodes 120, 122 receive various combinations of transmitted red and green light from both of the LEDs. The photodiodes 120, 122 are also connected to ground 220.

A reset signal 224 with a pull up resistor 226 may be provided to conventionally restart the microprocessor. It may be desirable to have a status indicator light 228 and load resistor to signal the condition of the microprocessor 172 (e.g., operating or “on”).

It will be noted that power, such as the 24V power supply or the 5V power supply, and a ground reference may be provided through ring connections 230, 232, 234 or other connections to the stationary components of the apparatus.

Each of the photodiodes 120, 122 in the fluid composition sensor 373 and the photodiode in the bag sensor 73 has an amplifier and buffer 236, as shown in FIG. 18, interposed between the photodiode return signals FD2K (216), FD3K (218) and FD1K (208) and their respective connections PC2, PC3 and PC1 on the microprocessor 172. A return signal, for example FD2K (216) is received on the control card 130 within a guard ring 237 to maintain certain connections at a constant reference potential. The guard ring 237 is connected to one input of a trans-impedance amplifier 238, which also receives a reference voltage established by two resistors 240, 242 in series between the 15V power supply and ground. Transient currents may be shunted to ground through a capacitor 244. A voltage regulator 246 may be used to secure a constant analog ground. The photodiode signal 216 is connected to the other input of the trans-impedance amplifier. A feed back capacitor 248 and resistor 250 select gain on the trans-impedance amplifier 238. Output impedance of the trans-impedance amplifier 238 is governed by a resistor 252 and a bias voltage produced by a resistance ladder of two resistors 254, 256 in series between the 15V power supply and ground. A filter capacitor 258 blocks undesirable high frequency transient signals.

Signal amplification may also be provided through a non-inverting buffer amplifier 260. Preferably, a signal gain of about three may be provided. Conventional bias resistors 262, 264, 266 and filter capacitors 268, 270 establish the gain characteristics of the amplifier, as is known in the art. The output of the buffer amplifier 260 is connected to the microprocessor 172, for example at PC2.

The microprocessor 172 on the rotor can be used to control various devices related to processing blood or other fluids. Such devices, called herein “fluid control devices”, may include valves, pumps, radiation, heat or sealing devices, agitators, and similar devices. Generally such devices would provide information to the microprocessor 172 on the state or status of the device and would receive commands from the microprocessor to change state based on the prior status and sensed conditions. Conditions may be sensed by independent sensors, such as the fluid composition sensor described above or by sensors incorporated into a fluid control device. Circuitry for controlling an exemplary pinch valve 70, 71 is described herein and is representative of the functions of reporting the state of the device and of receiving commands to change the state of the device.

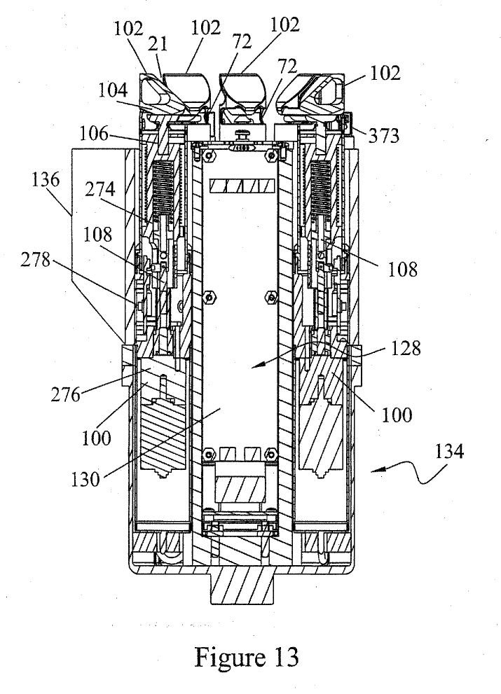

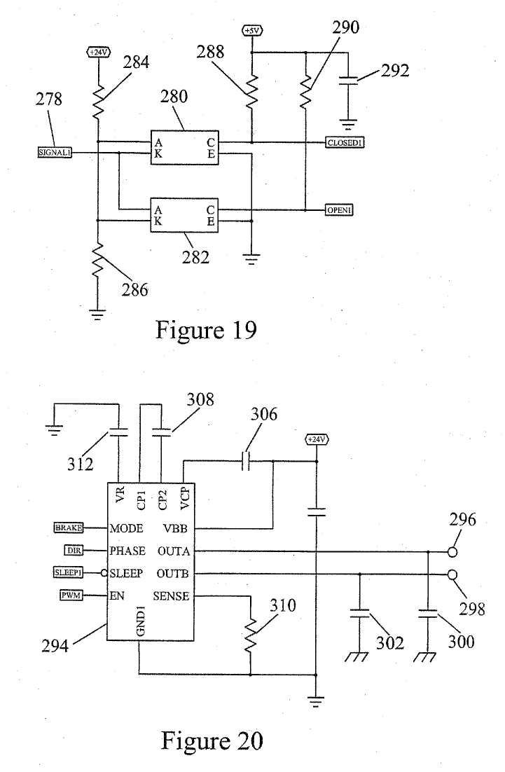

FIG. 19 shows a detection circuit 272 for detecting the state of the pinch valve 70, 71. The pinch valve 71, as shown in cross section in FIG. 13, comprises a spring-loaded plunger 274 driven along the central axis of the valve assembly by a direct current motor 276. A Halls effect sensor detects movement of the plunger and transmits a signal. This signal is generated in the relatively high voltage environment of the DC motor, in this example up to 24 volts. The signal is conveyed on signal line 278 to two optical couplers 280, 282, which produce a 5V on-off output corresponding to a closed or open condition of the pinch valve. This output is communicated to pins PD2 and PD3 of the microprocessor 172. The A input of the first optical coupler 280 and the K input of the second optical coupler 282 are both connected to the center of a voltage ladder comprised of two resistors 284, 286 in series between the 24V source and ground. The signal line 278 is connected to the K input of the first optical coupler 280 and to the A input of the second optical coupler 282. If the signal on line 278 is greater than the potential on the K input of the second optical coupler 282, an output will be generated on the C output of the second optical coupler 282, indicating that the pinch valve 71 is open. If the signal on the line 278 is less than the potential on the A input of the first optical coupler 280, which is the same potential as that of the K input of the second optical coupler 282, an output will be generated on the C output of the first optical coupler 280, indicating that the pinch valve 71 is closed. The E outputs of both optical couplers 280, 282 connect to ground. Pull up resistors 288, 290 connect each of the C outputs to the 5V source to provide a stable floor to the output signals. A filter capacitor 292 may also be used to divert transient signals to ground.

As explained above, the on-rotor microprocessor 172 may be used to control various fluid-control and process devices, such as pumps, directional valves, radio-frequency sealers, and similar devices. The exemplary pinch valve 71 is opened and closed by the action of the DC (direct current) motor 276. The microprocessor 172 issues command signals to a pulse-width modulated bi-directional H-bridge circuit 294. The microcomputer issues a stop command on a brake line; a direction command on a DIR line; an idle command on a Sleep1 line, and a pulse-width command on a PWM line. The pulse width command controls the speed of the motor. The idle command places the pinch valve in a neutral state. The direction command determines the direction of rotation of the motor and thus whether the pinch valve 71 is opening or closing. The brake command holds the motor and valve in a current condition. In response to the received commands, the H-bridge circuit 294 produces a positive or negative power pulse of an appropriate duration on output lines 296, 298. The output lines 296, 298 are each connected to chassis or earth ground through filter capacitors 300, 302. The 24V power supply is connected to the H-bridge circuit 294 with a storage capacitor 304 to respond to short-term power demands, such as a start-up surge. The H-bridge circuit 294 has an internal switched capacitor power supply and bootstrap capacitors 306 and 308 are connected externally to complete these known power supply circuits. A resistor 310 connected to the ground side of the 24V power connections draws a small current, which is sensed by the H-bridge circuit 294 when active power is present. A filter capacitor 312 connects the internal power supply to ground.

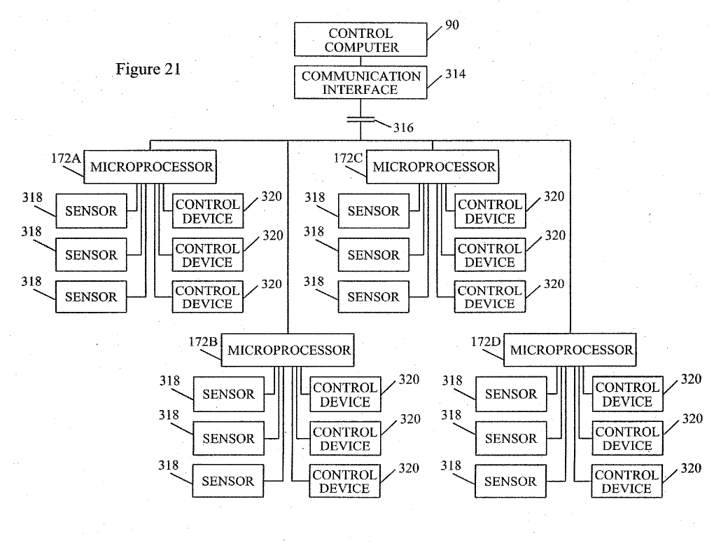

As shown schematically in FIG. 21, the control structure of on-rotor control circuits allows software control functions to be distributed on the main control computer 90 and on satellite microprocessors 172. A communications interface 314 provides reduced channel (preferably single channel) communications to all on-rotor microprocessors across a communications link 316 between the stationary portions of the separation apparatus and the movable rotor. The communication link 316 may be a slip ring or other suitable hardware or wireless connection, such as an infrared communications link. The communications interface 314 preferably provides an RS485 communications protocol running at 9600 bps. An RS485 communications protocol can address up to thirty-two devices. Other communications protocols could also be used. Unique software addresses allow the control computer 90 to address each of the microprocessors 172A, 172B, 172C, 172D over the same communication link. Communication is preferably bi-directional with control commands and status requests sent only from the control computer 90 to the microprocessors 172A, 172B, 172C, 172D. Each microprocessor gathers information from sensors 318 and both receives data from and transmits commands to control devices 320.

The control computer 90 will originate all bi-directional communications. Each command will be acknowledged when received by a designated microprocessor after passing a cyclic redundancy check. The on-rotor microprocessors 172 respond to control computer messages and no unsolicited messages are sent from the microprocessors 172 to the control computer 90. In addition to individual messages, broadcast messages can be sent to all microprocessors using a predetermined broadcast address. It is preferred that the interface uses a variable length message packet including a fixed length header and a variable length body. The length of the message body varies based on the message type. All messages should be pre-formatted before being sent.

The operation of the separation apparatus in accordance to an illustrative separation protocol with on-rotor control will now be described. Four discrete volumes of blood are separated into a plasma component, a first cell component comprising platelets, white blood cells, some red blood cells and a small volume of plasma (later the “buffy coat” component) and a second cell component mainly comprising red blood cells. Each volume of blood is contained in a separation bag 1 of a bag set represented in FIG. 2, in which it has previously been collected from a donor using the collection tube 5. These bags sets are called hereafter first, second, third and fourth separation sets, respectively. After the blood collection, the collection tube 5 has been sealed and cut close to the separation bag. Typically, the volumes of blood are not the same in the four separation bags 1, and the hematocrit varies from one separation bag 1 to another bag. Consequently, the separation bags 1 have slightly different weights. Four separation bags 1 are loaded into the four separation cells 40. The lids 47 are closed and locked, whereby the separation bags 1 are secured by their upper edge to the containers 41 (the pins 48 of the securing means pass then through the holes 8 in the upper corner of the separation bags 1 and engage the recesses 49 or the securing means).

The tubes 4 from the separation bags 1 are inserted in the slot 118 on the fluid composition sensor 373. The tubes 17 connecting the separations bags 1 to the plasma component bags 2, through the T connectors 16, are inserted in the groove 72 of the first pinch valve members 70. The tubes 18 connecting the separations bags 1 to the buffy coat component bags 15, through the T connector 16, are inserted in the groove 72 of the second pinch valve members 71. The four plasma component bags 2, the four buffy coat component bags 15, the four red blood cell component bags 3 and the four leuko-reduction filters 13 are inserted in the central compartment 34 of the rotor. The four plasma component bags 2 are respectively placed in direct contact with the pouches 81 to 84 of the balancing means. The pinch valve members 70, 71 are closed by their respective microprocessors and the breakable stoppers 9 in the tubes 4 connecting the separation bags 1 to the T connectors 16 are manually broken.

At the onset of a second stage, all the pinch valve members 70, 71 are closed. The rotor is set in motion by the centrifuge motor 36 and its rotation speed increases steadily until it rotates at a first centrifugation speed. The pumping station 60 is actuated so as to pump a predetermined overall volume of hydraulic liquid into the four hydraulic chambers 51, at a constant flow rate. If located on the rotor, the pumping station 60 may be controlled by one or more microprocessors 172. This overall volume of liquid is predetermined taking into account the maximum variation of weight between blood donations, so that, at the end of the second stage, the weights in the various separation cells 40 are substantially equal and the rotor is substantially balanced, whatever the specific weights of the separation bags 1 that are loaded in the separation cells 40. Note that this does not imply that the internal cavity 43 of the separation cells 40 should be filled up at the end of the balancing stage. For the purpose of balancing the rotor, it suffices that there is enough hydraulic liquid in the separation cells 40 for equalizing the weights therein, and it does not matter if an empty space remains in each separation cell 40 (the size of this empty space essentially depends on the volume of the internal cavity 43 of a separation cell 40 and the average volume of a blood donation). Because the hydraulic chambers 51 are interconnected, the distribution of the overall volume of hydraulic liquid between the separations chambers 40 simply results from the rotation of the rotor. When the weights of the separation bags 1 are the same, the distribution of the hydraulic liquid is even. When they are not, the distribution of the hydraulic liquid is uneven, and the smaller the weight of a specific separation bag 1, the larger the volume of the hydraulic fluid in the associated hydraulic chamber 51.

A third stage is initiated by a command from the control computer 90 to at least one microprocessor 172 (preferably all microprocessors), which then directs the process as far as actions on the rotor are concerned. All pinch valve members 70, 71 are closed. Under control of the control computer 90, the rotor is rotated at a second centrifugation speed (high sedimentation speed or “hard spin”) for a predetermined period of time that is so selected that, whatever the hematocrit of the blood in the separation bags 1, the blood sediments in each of the separation bag 1 at the end of the selected period to a point where the hematocrit of the outer red blood cell layer is about ninety and the inner plasma layer does not substantially contain any more cells, the platelets and the white blood cells forming then an intermediary layer between the red blood cell layer and the plasma layer. This condition may be sensed by the individual microprocessors 172 and reported to the control computer 90.

At the onset of a fourth stage, the rotation speed is decreased to a third centrifugation speed, the four first pinch valve members 70 controlling access to the plasma component bags 2 are opened by their respective microprocessors, and the pumping station 60 is actuated so as to pump hydraulic liquid at a first constant flow rate into the hydraulic chambers 51 and consequently squeeze the separation bags 1 and cause the transfer of plasma into the plasma component bags 2. When blood cells are detected by the bag sensor 73 or fluid composition sensor 373 in the separation cell 40 in which this detection occurs first, the corresponding microprocessor 172 closes first pinch valve member 70, either immediately or after a predetermined amount of time selected in view of the volume of plasma that it is desirable in the buffy coat component to be expressed in a next stage. The control computer 90 may stop the pumping station 60.

Following the closure of the first pinch valve member 70 of the first separation set (i.e. the first pinch valve of the group of first pinch valve members 70) to close, the pumping station 60 is actuated anew so as to pump hydraulic liquid at a second, lower, flow rate into the hydraulic chambers 51 and consequently squeeze the three separation bags 1 whose outlet is not closed by the corresponding first pinch valve members 70. When blood cells are detected by another microprocessor 172 in the separation cell 40 in which this detection occurs second, the pumping station 60 is stopped and the corresponding first pinch valve member 70 is closed by the microprocessor 172. A report is sent to the control computer 90.

Following the closure of the first pinch valve member 70 of the second separation set to close, the pumping station 60 is actuated anew so as to pump hydraulic liquid at the second flow rate into the hydraulic chambers 51 and consequently squeeze the two separation bags 1 whose outlet is not closed by the corresponding first pinch valve members 70. When blood cells are detected by the third microprocessor 172 in the separation cell 40 in which this detection occurs third, the corresponding first pinch valve member 70 is closed by its microprocessor 172. A report is sent to the control computer 90 and the pumping station 60 may be stopped.

After the closure of the first pinch valve member 70 of the third separation set, the pumping station 60 is actuated anew so as to pump hydraulic liquid at the second flow rate into the hydraulic chambers 51 and consequently squeeze the separation bag 1 whose outlet is not yet closed by the corresponding first pinch valve member 70. When blood cells are detected by the microprocessor 172 in the separation cell 40 in which this detection occurs last, the corresponding first pinch valve member 70 is closed by the third microprocessor. A report is sent to the control computer 90 and the pumping station 60 may be stopped.

In the plasma component transfer process described above, the transfer of the four plasma components starts at the same time, run in part simultaneously and stop independently of each other upon the occurrence of a specific event in each separation bag (detection of blood cells by the bag sensor). As a variant, when the second flow rate is sufficiently low and the closing of the first pinch valve member 70 occurs almost simultaneously with the detection of blood cells in the separation bags, then the pumping station can be continuously actuated during the fourth stage. The fourth stage ends when the four first pinch valve members 70 are closed.

In a fifth stage, a buffy coat component is transferred into the buffy coat component bags 15. The control computer 90 is programmed to start the fifth stage after the four first pinch valve members 70 are closed, upon receiving information from the last bag microprocessor 172 to detect blood cells. At the onset of this stage, the rotation speed remains the same (third centrifugation speed), a first of the four second pinch valve members 71 controlling access to the buffy coat component bags 15 is opened by its microprocessor 172, and the pumping station 60 is actuated so as to pump hydraulic liquid at a third constant flow rate into the hydraulic chambers 51 and consequently squeeze the separation bag 1 in the separation cell 40 associated with the opened second pinch valve members 71 and cause the transfer of the buffy coat component into the buffy coat component bag 2 connected to this separation bag 1.

After a predetermined period of time after blood cells are detected by the tube sensor 74 in the separation cell 40 associated with the opened second pinch valve member 71, the pumping station 60 is stopped and the second pinch valve member 71 is closed by the microprocessor 172. After the first pinch valve of the set of second pinch valves 71 has been closed by its microprocessor 172 (i.e. the first pinch valve of the group of second pinch valve members 71), a second pinch valve of the set of second pinch valves 71 is opened by its associated microprocessor 172, and a second buffy coat component is transferred into a buffy coat component bag 2, in the same way as above. The same process is successively carried out to transfer the buffy coat component from the two remaining separation bags 1 into the buffy coat component bag 2 connected thereto. In the buffy coat component transfer process described above, the transfers of the four buffy coat components are successive, and the order of succession is predetermined. However, each of the second, third and four transfers starts following the occurrence of a specific event at the end of the previous transfer (detection of blood cells by the tube sensor 373 or closing of the second valve member 71).

The control unit 90 is programmed to start a sixth stage after the four (second) pinch valve members 71 are closed, upon receiving information from the last of the microprocessors 172. The rotation speed of the rotor is decreased until the rotor stops, the pumping station 60 is actuated so as to pump the hydraulic liquid from the hydraulic chambers 51 at a high flow rate until the hydraulic chambers 51 are empty, and the first and second pinch valve members 70, 71 are actuated by the microprocessors 172 so as to seal and cut the tubes 17, 18. The blood cells remain in the separation bags 1. When the sixth stage is completed, the four bag sets are removed from the separation apparatus and each bag set is separately handled manually.

The breakable stopper 10 blocking the communication between the separation bag 1 and the tube 6 connected thereto is broken, as well as the breakable stopper 14 blocking the communication between the second satellite bag 3 and the tube 6. The storage solution contained in the second satellite bag 3 is allowed to flow by gravity through the leuko-reduction filter 13 and into the separation bag 1, where it is mixed with the red blood cells so as to lower the viscosity thereof. The content of the separation bag 1 is then allowed to flow by gravity through the filter 13 and into the second satellite bag 3. The filter 13 traps the white blood cells, so that substantially only red blood cells are collected into the second satellite bag 3.

It will be apparent to those skilled in the art that various modifications can be made to the apparatus and method described herein. Thus, it should be understood that the invention is not limited to the subject matter discussed in the specification. Rather, the present invention is intended to cover modifications and variations.

1. An apparatus for processing biologic fluids comprising
a centrifuge rotor adapted to rotate about an axis;
a fluid receptacle on said rotor for receiving a fluid to be processed; and
a control circuit on said rotor, said control circuit being responsive to a condition of said fluid to control processing of said fluid.

2. The apparatus of claim 1 further comprising
a control computer controlling operation of said apparatus.

3. The apparatus of claim 2 further comprising
a plurality of control circuits, and
a common communications interface, each of said control circuits communicating with said control computer through said common communications interface.

4. The apparatus of claim 3 wherein said common communications interface is a slip ring or an infrared communications link.

5. (canceled)

6. The apparatus of claim 3 wherein each control circuit has an address and said control computer periodically accesses a selected control circuit through said common interface through said address.

7. (canceled)

8. The apparatus of claim 3 wherein said control computer originates all bi-directional communications with said control circuits.

9. The apparatus of claim 8 wherein a selected control circuit completes a certain fluid processing procedure after receiving a communication from said control computer without requiring additional commands from said control computer.

10. The apparatus of claim 9 wherein said selected control circuit reports results of said certain fluid processing procedure only in response to a further communication from said control computer.

11. The apparatus of claim 1 further comprising
at least one sensor for sensing fluid in said fluid receptacle, said sensor being in electrical communication with said control circuit.

12. (canceled)

13. The apparatus of claim 1 further comprising
at least one fluid control device in electrical communication with said control circuit for manipulating fluid in said fluid receptacle.

14. The apparatus of claim 13 wherein said fluid control device is a valve, a pump, a radiation device, a sealing device, or an agitation device.

15. (canceled)

16. (canceled)

17. (canceled)

18. (canceled)

19. The apparatus of claim 1 wherein said fluid receptacle comprises a removable set of bags, said bags being in fluid communication through at least one tube and wherein said apparatus further comprises
at least one sensor on said rotor in electrical communication with said control circuit, said sensor detecting a condition of fluid in said set of bags; and
a valve on said rotor controlled by said control circuit, said valve controlling fluid flow in said tube.

20. The apparatus of claim 19 further comprising
a control computer mounted off of said rotor on a stationary portion of said apparatus, said control computer controlling operation of said apparatus,
a plurality of control circuits on said rotor, and
a common communications interface between said stationary portion and said rotor, each of said control circuits communicating with said control computer through said common communications interface.

21. The apparatus of claim 1 wherein said control circuit comprises a programmable microprocessor.

22. An apparatus for processing biologic fluids comprising
a centrifuge rotor adapted to rotate about an axis;
a fluid receptacle on said rotor for receiving a fluid to be processed; and
a control circuit on said rotor, said control circuit being responsive to a condition of said fluid to control processing of said fluid
a control computer controlling operation of said apparatus, said control computer being mounted on a non-rotating portion of said apparatus;
a common communications interface, said control circuit communicating with said control computer through said common communications interface, said control circuit completing a certain fluid processing procedure after receiving a communication from said control computer without requiring additional commands from said control computer.

23. The apparatus of claim 22 wherein said common communications interface is a slip ring or an infrared communications link.

24. (canceled)

25. The apparatus of claim 22 further comprising a plurality of control circuits and wherein each control circuit has an address and said control computer periodically accesses a selected control circuit through said common interface through said address.

26. The apparatus of claim 25 wherein said control computer originates all bi-directional communications with said control circuits.

27. The apparatus of claim 26 wherein said selected control circuit reports results of said certain fluid processing procedure only in response to a further communication from said control computer.

28. The apparatus for processing biologic fluids comprising
a centrifuge rotor adapted to rotate about an axis;
a fluid receptacle on said rotor for receiving a fluid to be processed; and
a plurality of control circuits on said rotor, each control circuit being responsive to a condition of said fluid to control processing of said fluid;
a control computer controlling operation of said apparatus, said control computer being mounted on a non-rotating portion of said apparatus;
a common communications interface, said control circuits communicating with said control computer through said common communications interface.

29. The apparatus of claim 28 wherein said common communications interface is a slip ring.

30. The apparatus of claim 28 wherein said common communications interface is an infrared communications link.

31. A method for controlling an apparatus for processing biologic fluids, said apparatus comprising a centrifuge rotor adapted to rotate about an axis; a fluid receptacle on said rotor for receiving a fluid to be processed, said method comprising
generating commands at a control computer controlling operation of said apparatus, said control computer being mounted on a non-rotating portion of said apparatus;
communicating said commands across a common communications interface to at least one control circuit mounted on said rotor,
sensing a condition of said fluid to control processing of said fluid by said control circuit;
completing a certain fluid processing procedure under control of said on-rotor control circuit after receiving a communication from said control computer without requiring additional commands from said control computer; and
reporting results of said fluid processing procedure by said control circuit to said control computer.

32. The method of claim 31 wherein the apparatus further comprises a plurality of control circuits and wherein said method comprises
addressing each control circuit by a unique address and said control computer periodically accesses a selected control circuit through said common interface through said address.

33. The method of claim 32 wherein said control computer originates all bi-directional communications with said control circuits.

34. The apparatus of claim 33 wherein said selected control circuit reports results of said certain fluid processing procedure only in response to a further communication from said control computer.
